(19) United States
(12) Patent Application Publication
(10) Pub. No.: US 2023/0411138 A1
(43) Pub. Date: Dec. 21, 2023

(54) TIME-OF-FLIGHT MASS SPECTROMETRIC ANALYSIS OF LABELLED ANALYTE IONS

(71) Applicant: Thermo Fisher Scientific (Bremen) GmbH, Bremen (DE)

(72) Inventor: Hamish Stewart, Bremen (DE)

(73) Assignee: Thermo Fisher Scientific (Bremen) GmbH, Bremen (DE)

(21) Appl. No.: 18/210,509

(22) Filed: Jun. 15, 2023

(30) Foreign Application Priority Data
Jun. 17, 2022 (GB) 2208939.5

(51) Int. Cl. H01J 49/40; H01J 49/06

(52) U.S. Cl. CPC H01J 49/406; H01J 49/061

(57) ABSTRACT

A method of analysing labelled analyte ions comprises fragmenting labelled analyte ions to produce analyte fragment ions and reporter ions or complementary ions, analysing the analyte fragment ions using a time-of-flight mass analyser operating in a first mode of operation, and analysing the reporter ions or the complementary ions using the time-of-flight mass analyser operating in a second mode of operation. In the first mode of operation, ions are caused to travel along a flight path having a first length, and in the second mode of operation, ions are caused to travel along a flight path having a second length, wherein the second length is greater than the first length.

### FIELD OF THE INVENTION

The present invention relates to methods of analysing ions, and in particular to methods of analysing labelled analyte molecules and/or ions using time-of-flight (ToF) mass analysers.

### BACKGROUND

Chemical tagging is a longstanding tool for the quantitation of analytes, the simplest form involving a comparison of peak intensity to that of a labelled standard of known concentration. When multiple different chemical tags are available with differing masses, such as multiple isotopomers, it becomes possible to mix several samples together and to analyse them in a single high throughput, multiplexed workflow.

An important application within this group is the Tandem Mass Tag (TMT) method (Thompson et al, Anal. Chem., 2003, 75, 1895-1904), marketed as TMT or iTRAQ (Isobaric Tagging for Relative Quantitation). This is a tandem method whereby the multiplexed tagged peptides possess the same m/z, so co-elute from liquid chromatography, and are co-isolated by a quadrupole mass filter. Upon fragmentation however, characteristic 1,2,6 reporter ions with differing m/z are generated and detected for quantitation. Simultaneous detection of peptide fragments allows peptide identification in the same step.

It is believed that there remains scope for improvements to methods of analysing labelled analyte molecules.

### SUMMARY

A first aspect provides a method of analysing labelled analyte ions, the method comprising:
fragmenting labelled analyte ions to produce analyte fragment ions and reporter ions or complementary ions;
analysing the analyte fragment ions using a time-of-flight mass analyser operating in a first mode of operation in which ions are caused to travel along a flight path having a first length; and analysing the reporter ions or the complementary ions using the time-of-flight mass analyser operating in a second mode of operation in which ions are caused to travel along a flight path having a second length, wherein the second length is greater than the first length.

Embodiments provide methods of analysing labelled analyte molecules, such as biomolecules labelled with isobaric tags (e.g. “tandem mass tags” (TMT) or “isobaric tags for relative and absolute quantitation” (iTRAQ)). Each tag may comprise a reporter region and a balancer region, such that each labelled analyte molecule may comprise a reporter region, a balancer region, and an analyte molecule. To analyse the labelled analyte molecules, they may firstly be ionised to produce labelled analyte ions, and the labelled analyte ions are then fragmented. When labelled analyte ions are fragmented, reporter ions may be produced (where a reporter ion is an ion of a reporter region) together with analyte molecule fragment ions. Additionally or alternatively, complementary ions may be produced (where a complementary ion is an ion of a combined balancer region and analyte molecule).

In the method, the analyte fragment ions and the reporter ions or the complementary ions are analysed using a mass analyser, i.e. so as to determine their mass to charge ratios (m/z) and/or intensities. The resulting m/z and/or intensity information for the analyte fragment ions can be used to identify the analyte molecules, and the m/z and/or intensity information for the reporter ions or the complementary ions can be used to quantify the analyte molecules.

In conventional mass spectrometric (MS) methods of analysing labelled analyte molecules, analyte fragment ions and reporter ions are analysed together in the same mass analyser scan. This can require a very high-resolution mass analyser, particular when using highly multiplexed isobaric tag sets, and particularly at the lower end of the m/z spectrum where the reporter ions appear. Thus, conventional methods of analysing labelled analyte molecules are commonly performed using high resolution electrostatic ion trap mass analysers such as electrostatic orbital traps, and more specifically Orbitrap™ FT mass analysers as made by Thermo Fisher Scientific. Although these analysers are particularly well suited to the analysis of labelled analyte molecules, they generally operate with a relatively slow repetition rate, particularly when compared to time-of-flight (ToF) mass analysers. This results in relatively slow experimental cycles and relatively low throughput.

Although some conventional time-of-flight (ToF) mass analysers can provide sufficiently high resolution to resolve both analyte fragment ions and the reporter ions (or complementary ions), such analysers are relatively complex and/or must have long ion flight paths to be able to do so with reasonable resilience to space charge effects.

In the methods of various embodiments, the analyte fragment ions and the reporter ions (or the complementary ions) are analysed using a time-of-flight (ToF) mass analyser that can operate in (at least) two different modes of operation, namely a first mode of operation in which ions are caused to travel along a flight path having a first length and a second mode of operation in which ions are caused to travel along a flight path having a second greater length. Increasing the length of the ion flight path in the second mode of operation has the effect of increasing the resolution of the analyser, but decreases the m/z range of ions that can be analysed. Where the increased path length is achieved by increasing the number of passes ions take through a cyclic segment of an ion path (as is described further below), this is because ions of lower m/z may overtake (i.e. lap) ions of higher m/z, such that it can become uncertain how many passes through the cyclic segment some ions (with m/z outside of a certain unambiguous m/z range) have taken, so that some peaks' m/z becomes uncertain. Additionally or alternatively, when operating the analyser with a constant repetition rate, for longer ion flight path lengths, high m/z ions in a particular repetition will not have sufficient time to reach the detector before the next repetition begins. The second mode of operation can accordingly be referred to as a “zoom” mode of operation (since the analyser in effect “zooms in” on a narrower m/z region of the m/z spectrum).

Although this loss of m/z range would be a problem in conventional methods of analysing labelled analyte molecules (because analyte fragment ions of interest can have relatively high m/z, while reporter ions can have relatively low m/z), the inventor has now recognised that by analysing the analyte fragment ions using the first mode of operation and analysing the reporter ions (or the complementary ions) using the second mode of operation, this problem is circumvented. This is because the wide m/z range first mode of operation is particularly suited to the analysis of analyte fragment ions (which typically appear over a relatively wide range of m/z), and correspondingly the narrow m/z range but higher resolution second (“zoom”) mode of operation is particularly suited to the analysis of the reporter ions (which typically appear within a relatively narrow m/z range at relatively low m/z) or the complementary ions. Moreover, this has the effect of relaxing the required resolution in the first (“normal”) mode of operation, since the primary reason for this is the fact that the reporter ions (and the complementary ions) are very closely spaced in m/z.

Thus, the inventor has recognised that time-of-flight (ToF) mass analysers that have a variable path length are particularly well suited to the analysis of labelled analyte molecules. The use of a ToF analyser to analyse labelled analyte ions (e.g. instead of an electrostatic ion trap analyser) in turn facilitates increased instrument repetition rate and experimental throughput. It will be appreciated, therefore, that embodiments provide an improved methods of analysing labelled analyte molecules.

A further aspect provides a method of analysing labelled analyte molecules, the method comprising ionising labelled analyte molecules to produce labelled analyte ions, and analysing the labelled analyte ions using the method(s) described herein. These aspects and embodiments can, and in embodiments do, include any one or more or each of the optional features described herein.

The analyte molecules that are analysed in the various aspects and embodiments can be any suitable molecules for analysis, such as organic molecules, biomolecules, DNA, RNA, proteins, peptides, nucleic acids, and the like. In embodiments, the analyte molecules are peptides.

The analyte molecules may be labelled with a set of chemical labels, such as a set of isobaric tags. A set of isobaric tags is a set of tag molecules that have (approximately) the same mass, but yield characteristic reporter ions of differing mass upon fragmentation of labelled analyte ions. Suitable isobaric tags include Tandem Mass Tags (TMT) and Isobaric Tags for Relative and Absolute Quantitation (iTRAQ). Each tag may comprise (at least) a reporter region and a balancer region, e.g. such that each labelled analyte molecule comprises (at least) a reporter region, a balancer region, and an analyte molecule (e.g. a peptide). Embodiments are particularly suited to the analysis of analyte molecules labelled with highly multiplexed sets of isobaric tags, such as TMT10, 16 or 18, where the minimum spacing between reporter ion channels may be of the order of a few mDa, e.g. ˜6 mDa. Embodiments may also be used for lower multiplexed isobaric tag sets, such as TMT6 and 8, which have reporter ion channel spacings of the order of ˜1 Da.

The method(s) may be performed using an analytical instrument such as a mass spectrometer. The analytical instrument may comprise (at least) an ion source, a mass filter, a fragmentation device, and a time-of-flight mass analyser (as is described in further detail below). The analytical instrument may comprise a separation device coupled to the ion source.

The labelled analyte molecules may be provided in solution, the solution may be separated using the separation device, and the separated solution may be provided to the ion source for ionisation. The ion source may ionise the labelled analyte molecules to produce labelled analyte ions.

The labelled analyte ions may initially be analysed by the instrument operating in an MS1 mode of operation, so as to provide MS1 data. The MS1 data may include one or more ion peaks, with each ion peak corresponding to labelled analyte ions having a particular m/z (i.e. a particular precursor).

The labelled analyte ions may then be analysed by the instrument operating in an MS2 mode of operation, so as to provide MS2 data. Each precursor of interest identified from the MS1 data may be used to define an m/z window for the mass filter. The mass filter may then sequentially step through each m/z window, so as to sequentially select each precursor of interest. The fragmentation device may be operated in a fragmenting mode of operation, so that mass filtered labelled analyte ions are fragmented. When labelled analyte ions are fragmented, reporter ions may be produced (where a reporter ion is an ion of a reporter region) together with analyte molecule fragment ions. Additionally or alternatively, complementary ions may be produced (where a complementary ion is an ion of a combined balancer region and analyte molecule).

The resulting analyte fragment ions and reporter ions or complementary ions are then analysed using the time-of-flight analyser. The resulting mass to charge ratio (m/z) and/or intensity information for the analyte fragment ions may be used to identify the analyte molecules, and the mass to charge ratio (m/z) and/or intensity information for the reporter ions or the complementary ions may be used to quantify the analyte molecules.

The analyte fragment ions are analysed using the first mode of operation in which ions are caused to travel along a flight path having a first length, and the reporter ions or the complementary ions are analysed using the second mode of operation in which ions are caused to travel along a flight path having a second greater length.

The time-of-flight mass analyser may comprise one or more ion reflectors. In the first mode of operation ions may be caused to make n reflection(s) in the one or more ion reflectors, wherein n is an integer ≥0. In the second mode of operation ions may be caused to make m reflection(s) in the one or more ion reflectors, wherein m is an integer >n. In general, an “ion reflector” may be, for example, an ion mirror, a reflectron, an ion deflector, a lens, or similar.

The time-of-flight mass analyser may be a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors; and
a detector for detecting ions after they have completed a plurality of reflections between the ion mirrors, the detector located in proximity with the first end of the ion mirrors.

Analysing analyte fragment ions using the analyser operating in the first mode of operation may comprise:
injecting analyte fragment ions from the ion injector into the space between the ion mirrors, wherein the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y to the first end of the ion mirrors; and then causing the ions to travel to the detector for detection.

Analysing reporter ions or complementary ions using the analyser operating in the second mode of operation may comprise:
(i) injecting reporter ions or complementary ion from the ion injector into the space between the ion mirrors, wherein the ions complete a first cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) optionally repeating step (ii) one or more times; and then
(iv) causing the ions to travel to the detector for detection.

The multi-reflection time-of-flight (MR-ToF) mass analyser may further comprise a deflector or lens located in proximity with the first end of the ion mirrors. The deflector or lens may be located approximately equidistant (in the X direction) between the first and second ion mirrors. The deflector or lens may be arranged along the ion path after the first ion mirror reflection (in the first ion mirror) that the ion beam experiences after being injected from the injector, but before its second ion mirror reflection (in the second ion mirror). Correspondingly, the deflector or lens may be arranged along the ion path before the final ion mirror reflection (in the second ion mirror) that the ion beam experiences before arriving at the detector, but after its penultimate ion mirror reflection (in the first ion mirror).

Analysing analyte fragment ions using the analyser operating in the first mode of operation may comprise:
injecting analyte fragment ions from the ion injector into the space between the ion mirrors, wherein the ions follow a zigzag ion path having plural reflections between the ion mirrors in the direction X whilst: (a) drifting from the deflector or lens along the drift direction Y towards the second end of the ion mirrors, (b) reversing drift direction velocity in proximity with the second end of the ion mirrors, and (c) drifting back along the drift direction Y to the deflector or lens; and then causing the ions to travel from the deflector or lens to the detector for detection.

Analysing reporter ions or complementary ions using the analyser operating in the second mode of operation may comprise:
(i) injecting reporter ions or complementary ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) using the deflector or lens to reverse the drift direction velocity of the ions such that the ions are caused to complete a further cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iii) optionally repeating step (ii) one or more times; and then
(iv) causing the ions to travel from the deflector or lens to the detector for detection.

The multi-reflection time-of-flight (MR-ToF) mass analyser can comprise any suitable type of MR-ToF. For example, the analyser can comprise an MR-ToF having a set of periodic lenses configured to keep the ion beam focused along its flight path, e.g. as described in the article A. Verenchikov, et al., Journal of Applied Solution Chemistry and Modelling, 2017, 6, 1-22.

However, in particular embodiments, the analyser is a titled-mirror type multi-reflection time-of-flight mass analyser, e.g. of the type described in U.S. Pat. No. 9,136,101, the contents of which are incorporated herein by reference. Thus, the ion mirrors may be a non-constant distance from each other in the X direction along at least a portion, most or all of their lengths in the drift direction Y. The drift direction velocity of ions towards the second end of the ion mirrors may be opposed by an electric field resulting from the non-constant distance of the two mirrors from each other. This electric field may cause the ions to reverse their drift direction velocity in proximity with the second end of the ion mirrors and drift back along the drift direction towards the deflector.

Alternatively, the analyser may be a single focussing lens type multi-reflection time-of-flight mass analyser, e.g. of the type described in UK patent No. 2,580,089, the contents of which are incorporated herein by reference. Thus, the deflector may be a first deflector, and the analyser may comprise a second deflector located in proximity with the second end of the ion mirrors. The second deflector may be configured to cause the ions to reverse their drift direction velocity in proximity with the second end of the ion mirrors and drift back along the drift direction towards the first deflector. To do this, a suitable voltage may be applied to the second deflector, e.g. in the manner described in UK patent No. 2,580,089.

The step of analysing the analyte fragment ions may comprise analysing one or more first packets of ions, e.g. by injecting each first packet of ions into the ToF analyser. The step of analysing the reporter ions or the complementary ions may comprise analysing one or more second different packets of ions, e.g. by injecting each second packet of ions into the ToF analyser. Thus, for each precursor of interest, the analyser may perform two (or more) scans, i.e. such that the analyte fragment ions are analysed using a different analyser scan(s) to the reporter ions or the complementary ions.

In these embodiments, each first packet of ions may comprise only analyte fragment ions, or may comprise analyte fragment ions together with reporter ions and/or complementary ions. Where a first packet of ions includes reporter ions and/or complementary ions, these ions may optionally be deflected by the deflector so that they do not reach the detector (whereas most of all of the analyte fragment ions do reach the detector). Each second packet of ions may comprise only reporter ions and/or complementary ions, or may comprise reporter ions and/or complementary ions together with analyte fragment ions. Where a second packet of ions includes analyte fragment ions, these ions may optionally be deflected by the deflector so that they do not reach the detector (whereas most of all of the reporter ions or complementary ions do reach the detector).

The method may comprise generating and/or processing and/or analysing each first packet of ions using a first set of one or more instrument parameters, and generating and/or processing and/or analysing each second packet of ions using a second different set of one or more instrument parameters. The first set of one or more instrument parameters may be configured to provide improved sensitivity and/or resolution when generating and/or processing and/or analysing the analyte fragment ions (relative to the reporter ions or the complementary ions), and the second set of one or more instrument parameters may be configured to provide improved sensitivity and/or resolution when generating and/or processing and/or analysing the reporter ions or the complementary ions (relative to the analyte fragment ions).

The set of one or more instrument parameters may include, for example, one or more (RF or DC) voltages applied to any one or more of the components of the instrument, such as for example: the ion source, the ion inlet, any one or more ion transfer devices, the mass filter, the fragmentation device, and/or the analyser (e.g. its ion injector, ion reflectors, and/or detector), etc. In particular embodiments, the set of one or more instrument parameters include (i) one or more fragmentation parameters, such as a collision energy, of the fragmentation device; and/or (ii) a width of the mass filter's transmission window.

Thus, for example, the method may comprise generating each first packet of ions using a first mass filter transmission window width (i.e. where the mass filter is used to select a particular precursor of interest, which is fragmented, and where the resulting fragment ions are used to form each first packet of ions); and generating each second packet of ions using a second different mass filter transmission window width (i.e. where the mass filter is used to select the particular precursor of interest, which is fragmented, and where the resulting fragment ions are used to form each second packet of ions), e.g. where the first mass filter transmission window width is wider than the second mass filter transmission window width. Using a wider mass filter transmission window width beneficially provides increased sensitivity for analysis of the analyte fragment ions, while using a narrower mass filter transmission window width beneficially reduces interferences for analysis of the reporter ions or the complementary ions. It would instead be possible for the first mass filter transmission window width to be narrower than the second mass filter transmission window width.

The method may comprise generating each first packet of ions using one or more first fragmentation parameters, such as a first collision energy (i.e. where a particular precursor of interest is fragmented using the one or more first fragmentation parameters, such as the first collision energy, and where the resulting fragment ions are used to form each first packet of ions); and generating each second packet of ions using one or more second fragmentation parameters, such as a second different collision energy (i.e. where the particular precursor of interest is fragmented using the one or more second fragmentation parameters, such as the second collision energy, and where the resulting fragment ions are used to form each second packet of ions). The one or more first fragmentation parameters, such as the first collision energy may be configured to efficiently produce analyte fragment ions (relative to reporter ions or complementary ions), and the one or more second fragmentation parameters, such as the second collision energy may be configured to efficiently produce reporter ions or complementary ions (relative to analyte fragment ions). Higher collision energies are typically beneficial for generating low m/z fragment ions such as reporter ions, while lower collision energies are typically beneficial for generating mid-range or high m/z fragment ions such as analyte fragment ions. Thus, the first collision energy may be lower than the second collision energy, e.g. where reporter ions are generated and analysed. On the other hand, relatively lower collision energies are typically used to generate complementary ions, comparted to the collision energies used to generate analyte fragment ions. Thus, the first collision energy may be higher than the second collision energy, e.g. where complementary ions are generated and analysed.

In alternative embodiments, the steps of analysing the analyte fragment ions and analysing the reporter ions or the complementary ions may comprise analysing one or more single packets of ions, e.g. by injecting each packet of ions into the ToF analyser. Thus, for each precursor of interest, the analyser may perform a single scan, i.e. such that the analyte fragment ions are analysed using the same scan as the reporter ions or the complementary ions. In these embodiments, each packet of ions may comprise analyte fragment ions together with reporter ions and/or complementary ions.

The analyser may comprises an ion path comprising a cyclic segment, an ion injector for injecting ions into the ion path, at least one ion reflector arranged along the ion path, and a detector arranged at the end of the ion path.

The method may comprise:
(i) injecting a packet of ions comprising analyte fragment ions and reporter ions or complementary ions from the ion injector into the ion path such that both the analyte fragment ions and the reporter ions or the complementary ions travel along the ion path to the ion reflector;
(ii) causing (only) the analyte fragment ions to travel from the ion reflector to the detector for detection;
(iii) using the ion reflector to cause (only) the reporter ions or the complementary ions to complete one or more cycles along the cyclic segment of the ion path; and then (iv) causing the reporter ions or the complementary ions to travel from the ion reflector to the detector for detection.

The method may comprise:
(i) injecting a packet of ions comprising analyte fragment ions and reporter ions or complementary ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing (only) the analyte fragment ions to travel from the deflector or lens to the detector for detection;
(iii) using the deflector or lens to reverse the drift direction velocity of (only) the reporter ions or the complementary ions such that these ions are caused to complete a further cycle in which these ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the reporter ions or the complementary ions to travel from the deflector or lens to the detector for detection.

According to another aspect, there is provided a method of operating a time-of-flight (ToF) mass analyser that comprises:
an ion path comprising a cyclic segment;
an ion injector for injecting ions into the ion path;
at least one ion reflector arranged along the ion path; and
a detector arranged at the end of the ion path;
the method comprising:
(i) injecting a packet of ions comprising first ions and second ions from the ion injector into the ion path such that the first ions and the second ions travel along the ion path to the ion reflector;
(ii) causing (only) the first ions to travel from the ion reflector to the detector for detection;
(iii) using the ion reflector to cause (only) the second ions to complete one or more (e.g. further) cycles along the cyclic segment of the ion path; and then
(iv) causing the second ions to travel from the ion reflector to the detector for detection.

These aspects and embodiments can, and in embodiments do, include any one or more or each of the optional features described herein.

In these aspects and embodiments, the ToF analyser may be a cyclic analyser. The ion path includes a cyclic segment, wherein ions can make either zero or plural (repeated) passes of the cyclic segment when travelling along the ion path from the ion injector to the detector. For example, the ion path may comprise a first non-cyclic segment, a cyclic segment arranged downstream of the first non-cyclic segment, and a second non-cyclic segment arranged downstream of the cyclic segment. The ToF analyser comprises at least one ion reflector, such as a deflector, arranged along the ion path. The ion reflector may be used to cause ions to complete one or more (further) cycles along the cyclic segment of the ion path, e.g. by suitable application of (e.g. pulsed) voltage(s) to the ion reflector(s).

In the method, a packet of ions comprising first ions and second ions is injected into the ion path such that the ions travel along the ion path to the ion reflector. Before arriving at the ion reflector, the first and second ions may follow the same ion path, and can make either zero or one or more passes of the cyclic segment of the ion path. Then, (only) the first ions are caused to travel from the ion reflector to the detector for detection, while the ion reflector is used to cause (only) the second ions to complete one or more (e.g. further) cycles along the cyclic segment of the ion path before they are caused to travel from the ion reflector to the detector for detection. This may be done by suitably pulsing the magnitude of voltage(s) applied to the ion reflector, with suitable timing(s), such that only the second ions are caused to complete one or more (e.g. further) cycles whereas the first ions are not.

The first ions may be ions having m/z within a first relatively broad range. The second ions may be ions having m/z within a second different relatively narrow range. The second range may overlap with and may be encompassed by the first range.

According to another aspect, there is provided a method of operating a multi-reflection time-of-flight (MR-ToF) mass analyser that comprises:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors;
a detector for detecting ions after they have completed a plurality of reflections between the ion mirrors, the detector located in proximity with the first end of the ion mirrors; and a deflector or lens located in proximity with the first end of the ion mirrors;
the method comprising:
(i) injecting a packet of ions comprising first ions and second ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing (only) the first ions to travel from the deflector or lens to the detector for detection;
(iii) using the deflector or lens to reverse the drift direction velocity of (only) the second ions such that the second ions are caused to complete a further cycle in which the second ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the second ions to travel from the deflector or lens to the detector for detection.

These aspects and embodiments can, and in embodiments do, include any one or more or each of the optional features described herein.

A further aspect provides a non-transitory computer readable storage medium storing computer software code which when executed on a processor performs the method(s) described above.

A further aspect provides a control system for an analytical instrument, such as a mass spectrometer, the control system configured to cause the analytical instrument to perform the method(s) described above.

A further aspect provides an analytical instrument, such as a mass spectrometer, comprising the control system described above.

A further aspect provides an analytical instrument, such as a mass spectrometer, comprising:
a fragmentation device;
a time-of-flight (ToF) mass analyser operable in a first mode of operation in which ions are caused to travel along a flight path having a first length, and a second mode of operation in which ions are caused to travel along a flight path having a second length, wherein the second length is greater than the first length; and
a control system configured, when the instrument is being used to analyse labelled analyte ions, to:
cause the fragmentation device to fragment the labelled analyte ions to produce analyte fragment ions and reporter ions or complementary ions;
cause the time-of-flight mass analyser to analyse the analyte fragment ions using the first mode of operation; and
cause the time-of-flight mass analyser to analyse the reporter ions or the complementary ions using the second mode of operation.

A further aspect provides a time-of-flight (ToF) mass analyser comprising:
an ion path comprising a cyclic segment;
an ion injector for injecting ions into the ion path;
at least one ion reflector arranged along the ion path; and
a detector arranged at the end of the ion path;
wherein the analyser is configured to analyse ions by:
(i) injecting a packet of ions comprising first ions and second ions from the ion injector into the ion path such that the first ions and the second ions travel along the ion path to the ion reflector;
(ii) causing (only) the first ions to travel from the ion reflector to the detector for detection;
(iii) using the ion reflector to cause (only) the second ions to complete one or more (e.g. further) cycles along the cyclic segment of the ion path; and then
(iv) causing the second ions to travel from the ion reflector to the detector for detection.

A further aspect provides a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors;
a detector for detecting ions after they have completed a plurality of reflections between the ion mirrors, the detector located in proximity with the first end of the ion mirrors; and
a deflector or lens located in proximity with the first end of the ion mirrors; and
wherein the analyser is configured to analyse ions by:
(i) injecting a packet of ions comprising first ions and second ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing (only) the first ions to travel from the deflector or lens to the detector for detection;
(iii) using the deflector or lens to reverse the drift direction velocity of (only) the second ions such that the second ions are caused to complete a further cycle in which the second ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the second ions to travel from the deflector or lens to the detector for detection.

A further aspect provides an analytical instrument, such as a mass spectrometer, comprising the time-of-flight (ToF) mass analyser or the multi-reflection time-of-flight (MR-ToF) mass analyser described above.

These aspects and embodiments can, and in embodiments do, include any one or more or each of the optional features described herein.

### DESCRIPTION OF THE DRAWINGS

Various embodiments will now be described in more detail with reference to the accompanying Figures, in which:

FIG. 1 shows schematically the base TMT C₈H₁₆N⁺ reporter ion, with m/z 126;

FIG. 2 shows schematically an analytical instrument in accordance with embodiments;

FIG. 3 shows schematically an analytical instrument in accordance with embodiments;

FIG. 4 shows schematically a multi-reflection time-of-flight mass analyser in accordance with embodiments;

FIG. 5 shows schematically a multi-reflection time-of-flight mass analyser in accordance with embodiments;

FIG. 6 illustrates schematically a method of operating a multi-reflection time-of-flight mass analyser in accordance with embodiments;

FIG. 7 illustrates a DDA method in accordance with embodiments;

FIG. 8 illustrates a method with 5× zoom of TMT reporter ions and un-zoomed peptide fragment ions, in accordance with embodiments;

FIG. 9 illustrates a DDA method in accordance with embodiments;

FIG. 10A shows a plot of resolution versus ion number for a regular single pass mode of operation of a multi-reflection time-of-flight mass analyser, and FIG. 10B shows a plot of resolution versus ion number for a 3× zoom mode of operation of the multi-reflection time-of-flight mass analyser; and

FIG. 11 shows plots of resolution and signal versus number of passes through a multi-reflection time-of-flight mass analyser.

### DETAILED DESCRIPTION

Chemical tagging is a longstanding tool for the quantitation of analytes, the simplest form involving a comparison of peak intensity to that of a labelled standard of known concentration. When multiple different chemical tags are available with differing masses, such as multiple isotopomers, it becomes possible to mix several samples together and to analyse them in a single high throughput, multiplexed workflow.

An important application within this group is the Tandem Mass Tag (TMT) method (Thompson et al, Anal. Chem., 2003, 75, 1895-1904), marketed as TMT or iTRAQ (Isobaric Tagging for Relative Quantitation). This is a tandem method whereby the multiplexed tagged peptides possess the same m/z, so co-elute from liquid chromatography, and are co-isolated by a quadrupole mass filter. Upon fragmentation however, characteristic 1,2,6 reporter ions with differing m/z are generated and detected for quantitation. Simultaneous detection of peptide fragments allows peptide identification in the same step. A great advantage of this method is in the simplification of the full mass spectrum and sensitivity of co-isolation, by a factor of the level of the multiplexing.

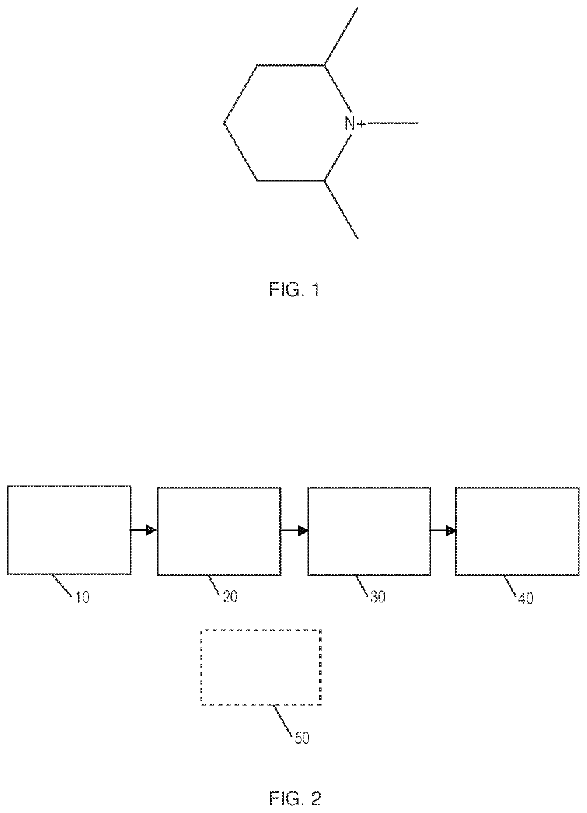

The earlier commercial implementation of TMT 6-plex produced reporter ions, shown in FIG. 1, from m/z 126-131 with isotopic mass separation generated by substitutions with ¹³C. A more recent advance was the 10-plex method which added substitution of nitrogen with ¹⁵N, giving a tiny 6.32 mDa mass defect versus ¹³C-only reporters, multiplying the number of accessible substituted tags, and splitting the reporter region into a series of isobaric doublets (McAlister et al, Anal. Chem., 2012, 84, 7469-7478). Even greater levels of multiplexing such as 18-plex have also been demonstrated.

There are however characteristic disadvantages to the method. Interferences between co-isolated isobaric peptides can contaminate the reporter ion channels, hindering accurate quantitation and preventing fast experimental cycles with shorter, more poorly separating, LC gradients. An additional isolation and fragmentation stage (MS3) may be used to remove interferences, but this also impacts speed and sensitivity. High resolution isolation, as provided by specialized time-of-flight (ToF) instruments, would be a more optimal solution, particularly if applied in sequence with quadrupole isolation.

A second problem is that the reporter ion doublets of the 10-plex and greater methods require ˜50K resolution at m/z 127 to differentiate and measure. This is outside of the range of most time-of-flight (ToF) analyser designs, and imposes tough, space charge related, limits of dynamic range upon the advanced ToF analysers capable of delivering such resolution.

Thus far, the TMT 10-plex method has been run on Orbitrap™ FT instruments, which excel at delivering high resolution at low m/z. However, the acquisition time required to achieve such resolution restricts the acquisition rate and limits the number of measurements. In the case of Orbitrap™ analysers, improved data processing methods, such as Phi-SDM, have been used to greatly improve resolution at speed (Bekker-Jenson et al, Mol. Cell. Proteomics, 2020, 14, 716-729). Space charge effects may also cause merging/coalescence of the reporter ion doublets in Orbitrap™ instruments, though this requires high ion loads normally limited by automatic gain control (AGC) procedures (Werner et al, Anal. Chem., 2014, 86, 3594-3601).

An important modification to the TMT method is TMT complementary ion quantification (Johnson et al, J. Proteome Res., 2021, 20, 3043-3052). Here, rather than quantifying from the reporter ions, the tagged peptide minus the reporter ion is generated at a low fragmentation energy and is measured. After separation of the reporter, the tag still contains a “balancer” component, which normally serves to equilibrate the mass of all tagged ions, but without the reporter component this creates a mirrored distribution of complementary ion channels. These channels may have relative intensities similar to the reporter ion distribution, and so may be used for quantitation. An advantage is that because they still have the original peptide attached, they are more robust to interferences from co-isolated peptides. The cost however is that as the complementary ion is much heavier than the reporter, but with the same mass difference between channels, vastly higher resolution is required to resolve the channels. Thus far, this process has been limited to 8 channel TMT methods with 1 Da spacing, whilst the equivalent 16 channel spacing, that requires 50K resolution normally, might easily require 500K if applied to an ion 10× heavier.

Few time-of-flight (ToF) analysers deliver sufficient resolution to be compatible with higher TMT multiplexed methods. Resolution in such analysers is typically limited by the length of the ion flight path, and the width of the peak that results from both the arrival time spread of ions at the detector and the detector's own time response. This latter fixed response creates a mass dependency in analyser resolution, and hinders low m/z measurement such as of the TMT reporter region (an inverse trend versus Orbitrap™ analysers).

Conventional ToF analysers typically incorporate an ion injection device, such as orthogonal accelerator or extraction trap, a detector, and an ion mirror that serves to focus ions to the detector surface. They may commonly also include lenses or deflectors after the ion source configured to appropriately shape and direct the beam.

A more advanced ToF analyser with very high resolution was introduced by Wollnik (DE3025764C2) that incorporate a pair of ion mirrors between which trapped ions may undergo multiple oscillations, before being released to a detector. A disadvantage of this system was that because lighter ions overtook/lapped heavier ions, mass analysis became greatly complicated. In general, increasing resolution for target ions via increased residency time, at the expense of restricting the mass range, may be referred to as “zooming in”.

Elongation of the ion mirrors by Nazarenki (SU1725289) produced an “open trap” or “multi-reflection time-of-flight (MR-ToF)” analyser with a fixed zig-zag flight path that eliminated the lapping problem. Improvements and commercialization were made by Verentchikov, by incorporation of periodic lenses between the mirrors that regularly corrected ion dispersion orthogonal to the ion oscillation (UK Patent No. 2,403,063).

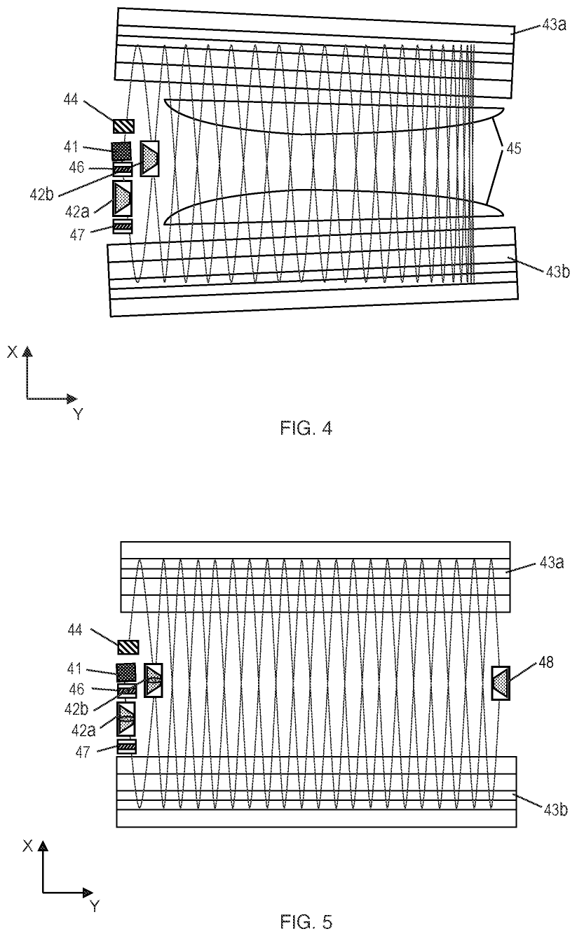

Later methods of controlling this ion dispersion have been proposed by Sudakov (WO2008/047891), Stewart (U.S. Pat. No. 10,964,520) and most notably by Grinfeld in U.S. Pat. No. 9,136,101. This latter method involves tilting the ions mirrors slightly, so that injected ions are allowed to spread out as they drift in a drift direction between the elongated mirrors. With each pass through the tilted mirrors and supporting stripe electrodes, the ions are deflected back, eventually having their drift velocity entirely reversed and being focused onto a detector at the starting side of the mirror system. A schematic diagram of this analyser is shown in FIG. 4 (and is described in more detail below).

Such analysers are capable of resolving TMT reporters, but must be relatively large (˜1 m²) to do so with reasonable space charge resilience. Because baseline resolution of peaks is less easily achievable due to tailing or other effects, the detectable ratio of the two peaks in the doublet may still be limited.

A special mode of operation covering this broad family of analysers was previously reported by Verenchikov et al., termed “Zoom Mode” (Verenchikov et al., Journal of Applied Solution Chemistry and Modelling, 2017, 6, 1-22). Here a deflector placed early in the ion path could be switched to a trapping voltage, forcing ions to undergo multiple passes up and down the mirrors, each containing the same number of oscillations between the mirrors. The great extension of flight path thus demonstrated vastly increased resolution, up to 500,000, but induced, as the name suggests, a severe loss of mass range.

Embodiments described herein address the difficulty resolving and thus accurately quantitating peaks within TMT reporter doublets or similar isobaric fragment tags, particularly as applied to multi-reflection time-of-flight (MR-ToF) analysers (and other ToF analysers).

As mentioned above, Orbitrap™ instruments are normally used for TMT methods, but these instruments can suffer somewhat from the slow repetition rate required to operate with such high resolution. This also forces slower experimental cycles and lower throughput, though it is not always clear whether this or contamination of precursor targets by co-eluting and co-isolating peptides dominate.

Most ToF analysers are too poorly resolving to be compatible at all with higher multiplexed TMT methods, and even relatively large MR-ToF systems may struggle with maintaining that resolution at higher ion loads, limiting dynamic range and the ratio of doublet peaks that may be characterised. High repetition rate injection devices such as orthogonal accelerators reduce the space charge burden per shot, but these can come with considerable sensitivity costs versus extraction traps, and advanced operation methods with deconvolution (such as via encoded frequent pulsing) can be required to make such sources compatible with the long flight times of multi-reflection ToF analysers. Space charge tolerant analysers such as the tilted mirrors analyser depicted in FIG. 4 can be compatible with these methods, but improved performance is still desirable.

Thus, particular embodiments are directed to improving the resolution and space charge resilience, and thus dynamic range, of a multi-reflection time-of-flight (MR-ToF) analyser to the TMT reporter ions used for quantitation, with minimum impact on the peptide fragments used for identification.

In accordance with embodiments described herein, a zoom mode is used solely for the TMT reporter (or complementary) ions, and a regular mode of operation is used for peptide fragment identification, e.g. within a data dependent TMT method. As is described in more detail below, the reporter ions (or the complementary ions) and the fragment ions may be analysed either in separate scans or in a single merged scan. The zoom mode multiplies the achievable resolution of the TMT reporters, and consequently also improves the space charge resilience and dynamic range of the analyser.

FIG. 2 illustrates schematically an analytical instrument, such as a mass spectrometer, that may be used to perform the method in accordance with embodiments. As shown in FIG. 2, the analytical instrument includes an ion source 10, a mass filter 20, a fragmentation device 30, and a time-of-flight (ToF) mass analyser 40.

The ion source 10 is configured to generate ions from a sample. The ion source 10 may be coupled to a separation device such as a liquid chromatography separation device or a capillary electrophoresis separation device (not shown), such that the sample which is ionised in the ion source 10 comes from the separation device. The ion source 10 can be any suitable ion source, such as an ion source that is compatible with the separation device. In embodiments, the ion source 10 is an electrospray ionisation (ESI) ion source, an atmospheric pressure ionisation (API) ion source, a chemical ionisation ion source, an electron impact (EI) ion source, or similar.

The mass filter 20 is arranged downstream of the ion source 10, and may be configured to receive ions from the ion source 10. The mass filter 20 may be configured to filter received ion according to their mass to charge ratio (m/z), e.g. such that only ions within a m/z window are onwardly transmitted by the mass filter 20, while ions outside of the mass filter's m/z window are rejected by the mass filter 20 and are not onwardly transmitted. The m/z width and the centre m/z of the mass filter's transmission window are controllable (variable), e.g. by suitable control of RF and DC voltages applied to the mass filter 20. Thus, for example, the mass filter may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The fragmentation device 30 is arranged downstream of the mass filter 20, and may be configured to receive most or all ions transmitted by the mass filter 20. The fragmentation device 30 may be configured to selectively fragment some or all of the received ions, i.e. so as to produce fragment ions. The fragmentation device 30 may be operable in a fragmentation mode of operation, whereby most or all received ions are fragmented so as to produce fragment ions (which may then be onwardly transmitted from the fragmentation device 30), and a non-fragmentation mode of operation, whereby most or all received ions are onwardly transmitted without being (deliberately) fragmented. It would also be possible for a non-fragmentation mode of operation to be implemented by causing ions to bypass the fragmentation device 30. The fragmentation device 30 may also be operable in one or more intermediate modes of operation, e.g. whereby the degree of fragmentation is controllable (variable). The fragmentation device 30 can also be operable in higher order (MS N) fragmentation modes of operation, e.g. whereby fragment ions are further fragmented one or more times by the fragmentation device 30.

The fragmentation device 30 can be any suitable type of fragmentation device that can be used to fragment labelled analyte ions to produce analyte fragment ions and reporter ions or complementary ions, such as for example a collision induced dissociation (CID) fragmentation device, an electron induced dissociation (EID) fragmentation device, a photodissociation fragmentation device, and so on. Numerous other types of fragmentation are possible.

In embodiments, the fragmentation device 30 is a collision induced dissociation (CID) fragmentation device. Thus, the fragmentation device may include a collision cell which may be filled with a collision gas, e.g. maintained at a relatively high pressure. Ions may be selectively fragmented in the collision cell by controlling (varying) the kinetic energy with which ions are caused to enter the collision cell. In a fragmentation mode of operation, ions may be accelerated so that they enter the collision cell with a relatively high kinetic energy, which may cause most or all of the accelerated ions to fragment. In a non-fragmentation mode of operation, ions may be caused to enter the collision cell with a relatively low kinetic energy, which may be insufficient to cause most or all of the ions to fragment. In intermediate modes, ions may be caused to enter the collision cell with intermediate kinetic energies.

The ToF analyser 40 may be arranged downstream of the fragmentation device 30, and may be configured to receive most or all ions onwardly transmitted from the fragmentation device 30. It would also be possible for the instrument to be configured such that the ToF analyser 40 can receive ions from the mass filter 20, e.g. if the instrument is configured such that in the non-fragmentation mode of operation ions are caused to bypass the fragmentation device 30. Thus, in general, the ToF analyser 40 may be configured to receive ions from the various upstream stages of the instrument, which can include unfragmented (“precursor” or “parent”) ions, fragment (“product” or “daughter”) ions, fragmented fragment (“granddaughter”) ions, and so on.

The ToF analyser 40 is configured to analyse received ions so as to determine their mass to charge ratio (m/z). To do this, the ToF analyser 40 is configured to pass ions along an ion path within a drift region of the analyser 40 (where the drift region is maintained at high vacuum (e.g. <1×10⁻⁵ mbar)), and to measure the time taken (the drift time) for ions to pass along the ion path. Ions may be accelerated into the drift region by an electric field, and may be detected by an ion detector arranged at the end of the ion path. The acceleration may cause ions having a relatively low m/z to achieve a relatively high velocity and reach the ion detector prior to ions having a relatively high m/z. Thus, ions arrive at the ion detector after a time determined by their velocity and the length of the ion path, which enables the m/z of the ions to be determined. Each ion or group of ions arriving at the detector may be sampled by the detector, and the signal from the detector may be digitised. A processor may then determine a value indicative of the time of flight and/or m/z of the ion or group of ions. Data for multiple ions may be collected and combined to generate a time of flight (“ToF”) spectrum and/or a mass spectrum.

The ToF mass analyser 40 can be any suitable ToF analyser. In general, the ToF analyser 40 may comprise an ion injector arranged at the start of an ion path, and an ion detector arranged at the end of the ion path. The analyser 40 may be configured to analyse ions by determining arrival times of ions at the detector (i.e., the time taken for ions to travel from the injector and to arrive at the detector via the ion path).

The ion injector can be in any suitable form, such as for example one or more (e.g., orthogonal) acceleration electrodes. However, in particular embodiments, the ion injector comprises an ion trap. The ion trap may be configured to receive ions (from the fragmentation device 30), and may be configured to accumulate a packet of ions, e.g. by accumulating ions during an accumulation time period. The ion trap may be configured to inject each accumulated packet ions into the ion path (e.g. by accelerating the packet of ions along the ion path), whereupon the ions of the packet may travel along the ion path to the detector.

The detector can be any suitable ion detector such as one or more conversion dynodes, optionally followed by one or more electron multipliers, one or more scintillators, and/or one or more photon multipliers, and the like. The detector may be configured to detect ions received at the detector, and may be configured to produce a signal indicative of an intensity of ions received at the detector as a function of (arrival) time. The m/z of the ions may then be determined from the measured arrival time.

The ion path may have any suitable form, such as being linear in the case of a linear ToF analyser, or including one or more reflections in the case of a ToF analyser comprising a reflectron or a multi-reflection time-of-flight (MR-ToF) analyser. The ion path can include a cyclic segment.

In particular embodiments, the analyser 40 is a multi-reflection time-of-flight (MR-ToF) analyser. Thus, the analyser 40 may comprise two ion mirrors spaced apart and opposing each other in a first direction X, each mirror being elongated generally along a drift direction Y between a first end and a second end, the drift direction Y being orthogonal to the first direction X. An ion injector may be located in proximity with the first end of the ion mirrors, and may be configured to inject ions into a space between the ion mirrors. A detector may be located in proximity with the first end of the ion mirrors, and may be configured to detect ions after they have completed a plurality of reflections between the ion mirrors. The analyser may be configured to analyse ions by injecting ions from the ion injector into the space between the ion mirrors, whereupon the ions may adopt a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors. The ions may then be caused to travel to the detector for detection.

It should be noted that FIG. 2 is merely schematic, and that the analytical instrument can, and in embodiments does, include any number of one or more additional components. For example, the instrument will typically comprise one or more ion transfer stage(s) arranged between the various illustrated components 10, 20, 30, 40, and configured to transfer ions from one component to the next. The one or more ion transfer stage(s) can include any suitable arrangement(s) of one or more ion guides, lenses and/or other ion optical devices.

As is illustrated in FIG. 2, the instrument may be under the control of a control unit such as an appropriately programmed computer, which may be configured to control the operation of various components of the instrument including the mass filter 20, fragmentation device 30, and the analyser 40, e.g. so as to cause the instrument to operate in a particular mode of operation and/or to perform the method(s) described herein. The control unit 50 may also receive and process data from various components, e.g. including mass spectral data from the analyser 40, etc., in accordance with embodiments described herein.

The instrument may be operable in various mode of operation, including a MS1 mode of operation and an MS2 mode of operation.

In the MS1 (or “full mass scan”) mode of operation, the mass filter 20 is operated in its transmission mode of operation and the fragmentation device 30 is operated in its non-fragmentation mode of operation, e.g. so that a wide m/z range (e.g. full mass range) of unfragmented (“precursor” or “parent”) ions are analysed by the analyser 40.

In the MS2 mode of operation, the mass filter 20 is operated in its filtering mode of operation and the fragmentation device 30 is operated in its fragmentation mode of operation, e.g. so that a selected narrow m/z range of precursor ions are fragmented and the resulting fragment (“product” or “daughter”) ions are analysed by the analyser 40. In the MS2 mode of operation, the centre of the mass filter's (narrow) m/z window can be sequentially altered between each of a plurality of different m/z values, e.g. so as to sequentially select (and fragment) each of a plurality of different precursor ions with respective different m/z. In a data dependent acquisition (DDA) MS2 mode of operation, the plurality of different m/z values may correspond to a plurality of different precursor ions identified from corresponding MS1 data (i.e. a full mass scan). In a data independent acquisition (DIA) MS2 mode of operation, the plurality of different m/z values may be taken from a predetermined (fixed) list, i.e. without reference to MS1 data.

The instrument may also be operable in one or more higher order fragmentation (MS^{N}) modes of operation, such as for example an MS3 mode of operation, whereby precursor ions are fragmented, at least some of the resulting fragment ions are themselves fragmented, and the second-generation fragment ions (“granddaughter ions”) are analysed by the analyser 40.

The ToF analyser 40 is operable in at least two modes of operation, namely a first mode of operation in which ions are caused to travel along a flight path (between the ion injector and the ion detector) having a first length and a second mode of operation in which ions are caused to travel along a flight path (between the ion injector and the ion detector) having a second, greater length. Increasing the length of the ion flight path in the second mode of operation has the effect of increasing the resolution of the analyser, but decreases the m/z range of ions that can be analysed. The second mode of operation can accordingly be referred to as a “zoom” mode of operation (since the analyser in effect “zooms in” on a narrower m/z region of the m/z spectrum). The ToF analyser 40 may optionally be operable in one or more further modes of operation, in which ions are caused to travel along a flight path (between the ion injector and the ion detector) having one or more different lengths.

The time-of-flight (ToF) mass analyser can be configured to have a variable path length in any suitable manner. In general, the ToF analyser 40 may have one or more ion reflectors (such as one or more ion mirrors and/or one or more reflectrons) configured to reflect ions. The ion path may be lengthened by increasing the number of reflections in the one or more ion reflectors that ions take before being detected.

Thus, for example, in the first mode of operation ions may not be reflected by an ion reflector before being detected, and in the second mode of operation ions may be reflected one or more times by one or more ion reflectors before being detected. Alternatively, in the first mode of operation ions may be reflected one or more times by one or more ion reflectors before being detected, and in the second mode of operation ions may be reflected more times by the one or more ion reflectors (than in the first mode) before being detected. For example, the ToF analyser may be switchable between a first (“V”) mode of operation in which ions are reflected once in an ion reflector (reflectron) before they are detected, and a second (“W”) mode of operation in which ions undergo three reflections (in two ion reflectors) before they are detected.

The ion path may also or instead be lengthened by increasing the number of passes in a cyclic segment of the ion path that ions take before being detected.

In particular embodiments, the analyser 40 is a multi-reflecting time-of-flight (MR-ToF) mass analyser that is operable in a single-pass “normal” mode of operation, and a multi-pass “zoom” mode of operation (as is described in detail below).

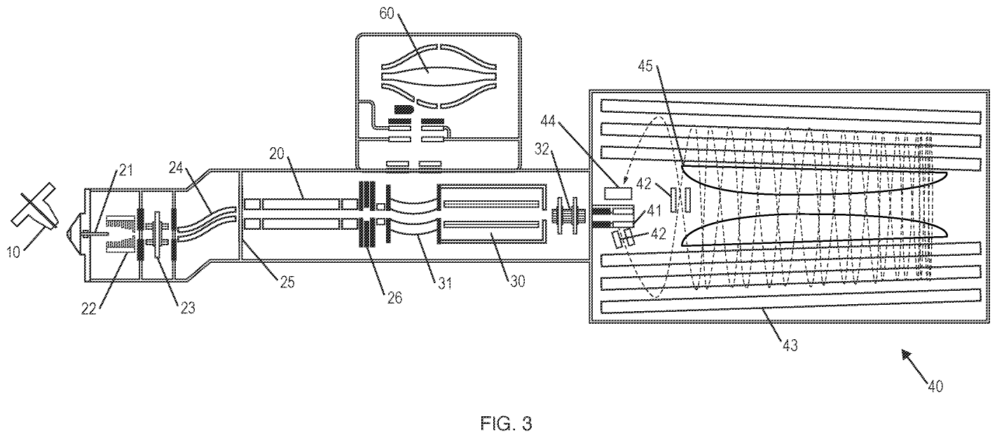

FIG. 3 shows schematically in more detail a mass spectrometer suitable for performing the methods of various embodiments. The instrument is a hybrid instrument incorporating an MR-ToF analyser 40 (of the type described in U.S. Pat. No. 9,136,101), a quadrupole mass filter 20, and an Orbitrap™ analyser 60. The instrument also includes an electrospray source 10, a collision cell 30, and the various ion guides etc. for a complete mass spectrometer. It will be understood that the instrument shown in FIG. 3 is a non-limiting example, and that numerous variations are possible.

In the embodiment depicted in FIG. 3, the instrument's ion source 10 is an electrospray ionisation (ESI) ion source. The instrument includes a vacuum interface, which includes a transfer tube 21, an ion funnel 22, a quadrupole pre-filter ion guide 23, and a so-called “bent flatapole” ion guide 24. The ion guide 24 may be of the design described in U.S. Pat. No. 9,536,722.

The instrument also includes a mass filter in the form of a quadrupole mass filter 20, an ion trap 31 in the form of a curved linear ion trap (“C-Trap”), and a collision cell 30 in the form of an ion routing multipole collision cell (“IRM”). Ions from the ion source 10 can be accumulated in the C-Trap 31 and/or collision cell 30 by opening and closing a gating electrode located in a charge detector assembly 26, which is arranged between the C-Trap 31 and the mass filter 20.

The instrument includes a time-of-flight (ToF) mass analyser 40 in the form of a multireflection time-of-flight (ToF) mass analyser. In the instrument depicted in FIG. 3, the analyser is of the tilted-mirror type described in U.S. Pat. No. 9,136,101, but it will be understood that any type of ToF analyser could be used.

As shown in FIG. 3, the instrument includes a multipole ion guide 32 to allow ions to be transferred from the collision cell 30 to the time-of-flight mass analyser 40. The time-of-flight mass analyser 40 includes an extraction trap 41, whereby ions are delivered from the collision cell 30 to the extraction trap 41 via the multipole ion guide 32. The ions are accumulated and cooled in the extraction trap 41.

The extraction trap 41 may incorporate two trapping regions, one at a relatively higher pressure for rapid ion cooling, and a second low pressure region for ion extraction. Ions are cooled in the high-pressure region and then transferred to the low-pressure region, where they are pulse ejected into the ToF analyser via a pair of deflectors 42. Ions oscillate between a pair of mirrors 43, which are tilted relative to one another so that the ion path is slowly deflected and redirected back to a detector 44. Correcting stripe electrodes 45 counter the loss of ion focus otherwise induced by the non-parallelism of the mirrors.

As also shown in FIG. 3, the instrument may optionally include a second mass analyser in the form of an electrostatic mass analyser 60, such as an orbital ion trap mass analyser, and more specifically an Orbitrap™ FT mass analyser as made by Thermo Fisher Scientific. This hybridized instrument is described in more detail in U.S. Pat. No. 10,699,888, the contents of which are incorporated herein by reference.

Ions may be collected in the ion trap 31, and may then either be ejected orthogonally to the Orbitrap™ analyser 60 for analysis without entering the collision or reaction cell 30, or the ions can be transmitted axially to the collision or reaction cell 30. Ions transmitted to the collision or reaction cell 30 can be either fragmented by collisions with a collision gas and/or a reagent in the collision cell 30, or merely cooled by collisions with a gas at lower energies that do cause the ions to fragment. Once accumulated in the collision cell 30, ions can be either be ejected into the mass analyser 40 for analysis (via the multipole ion guide 32), or ejected into the Orbitrap™ analyser 60 for analysis (via the C-trap 31).

FIGS. 4 and 5 illustrate schematically detail of exemplary embodiments of the variable path length analyser 40. In these embodiments, the analyser 40 is a multi-reflecting time-of-flight (MR-ToF) mass analyser that is operable in a single-pass “normal” mode of operation, and a multi-pass “zoom” mode of operation.

As shown in FIGS. 4 and 5, the multi-reflection time-of-flight analyser 40 includes a pair of ion mirrors 43a, 43b that are spaced apart and face each other in a first direction X. The ion mirrors 43a, 43b are elongated along an orthogonal drift direction Y between a first end and a second end.

An ion source (injector) 41, which may be in the form of an ion trap, is arranged at one end (the first end) of the analyser. The ion source 41 may be arranged and configured to receive ions from the fragmentation device 30. Ions may be accumulated in the ion source 41, before being injected into the space between the ion mirrors 43a, 43b. As shown in FIGS. 4 and 5, ions may be injected from the ion source 41 with a relatively small injection angle or drift direction velocity, creating a zig-zag ion trajectory, whereby different oscillations between the mirrors 43a, 43b are separate in space.

One or more lenses and/or deflectors may be arranged along the ion path, between the ion source 41 and the ion mirror 43b first encountered by the ions. For example, as shown in FIGS. 4 and 5, a first out-of-plane lens 46, an injection deflector 42a, and a second out-of-plane lens 47 may be arranged along the ion path, between the ion source 41 and the ion mirror 43b first encountered by the ions. Other arrangements would be possible. In general, the one or more lenses and/or deflectors may be configured to suitably condition, focus and/or deflect the ion beam, i.e. such that it is caused to adopt the desired trajectory through the analyser.

The analyser 40 also includes another deflector 42b, which is arranged along the ion path, between the ion mirrors 43a, 43b. As shown in FIGS. 4 and 5, the deflector 42b may be arranged approximately equidistant between the ion mirrors 43a, 43b, along the ion path after its first ion mirror reflection (in ion mirror 43b), and before its second ion mirror reflection (in the other ion mirror 43a).

The analyser also includes a detector 44. The detector 44 may be any suitable ion detector configured to detect ions, and e.g. to record an intensity and time of arrival associated with the arrival of ion(s) at the detector. Suitable detectors include, for example, one or more conversion dynodes, optionally followed by one or more electron multipliers, and the like.

In its “normal” mode of operation, ions are injected from the ion source 41 into the space between the ion mirrors 43a, 43b, in such a way that the ions adopt a zigzag ion path having plural reflections between the ion mirrors 43a, 43b in the X direction, whilst: (a) drifting along the drift direction Y from the deflector 42b towards the opposite (second) end of the ion mirrors 43a, 43b, (b) reversing drift direction velocity in proximity with the second end of the ion mirrors 43a, 43b, and then (c) drifting back along the drift direction Y to the deflector 42b. The ions can then be caused to travel from the deflector 42b to the detector 44 for detection.

In the analyser of FIG. 4, the ions mirrors 43a, 43b are both tilted with respect to the X and/or drift Y direction. It would instead be possible for only one of the ion mirrors 43a, 43b to be tilted, and e.g. for the other one of the ion mirrors 43a, 43b to be arranged parallel to the drift Y direction. In general, the ion mirrors are a non-constant distance from each other in the X direction along most or all of their lengths in the drift direction Y. The drift direction velocity of ions towards the second end of the ion mirrors is opposed by an electric field resulting from the non-constant distance of the two mirrors from each other, and this electric field causes the ions to reverse their drift direction velocity in proximity with the second end of the ion mirrors and drift back along the drift direction towards the deflector.

The analyser depicted in FIG. 4, further comprises a pair of correcting stripe electrodes 45. Ions travelling down the drift length are slightly deflected with each pass through the mirrors 43a, 43b and the additional stripe electrodes 45 are used to correct for the time-of-flight error created by the varying distance between the mirrors. For example, the stripe electrodes 45 may be electrically biased such that the period of ion oscillation between the mirrors is substantially constant along the whole of the drift length (despite the non-constant distance between the two mirrors from). The ions eventually find themselves reflected back down the drift space and focused at the detector 44.

Further detail of the tilted-mirror type multireflection time-of-flight mass analyser of FIG. 4 is given in U.S. Pat. No. 9,136,101, the contents of which are incorporated herein by reference.

In the analyser of FIG. 5, the ion mirrors 43a, 43b are parallel to each other. In this embodiment, in order to cause the ions to reverse their drift direction velocity in proximity with the second end of the ion mirrors and drift back along the drift direction towards the deflector, the analyser includes a second deflector 48 at the second end of the ion mirrors 43a, 43b.

As also shown in FIG. 5, in this embodiment, a lens can be included in the injection deflector 42a and/or in the deflector 42b. Thus, the ion beam is allowed to expand a short way into the analyser before meeting a long-focus lens, which has the effect of focussing the ion beam along its length. The lens may be an elliptical drift focusing (converging) lens mounted within the deflector 42b. The second deflector 48, which may also include a lens, is used to reverse the beam direction whilst maintaining control of focal properties.

Further detail of the single-lens type multireflection time-of-flight mass analyser of FIG. 5 is given in UK Patent No. GB 2,580,089, the contents of which are incorporated herein by reference.

In the analysers depicted in FIGS. 4 and 5, the ion beam is allowed to spread out relatively broadly (in the drift direction Y) for most of its flight path. This is in contrast, for example, with multi-reflecting time-of-flight (MR-ToF) mass analysers which use a set of periodic lenses to focus the ion beam along its entire flight path, e.g. as described in the article A. Verenchikov, et al., Journal of Applied Solution Chemistry and Modelling, 2017, 6, 1-22. A significant advantage of allowing the ion beam to spread out broadly for most of its flight path is that space charge effects are reduced, which can be a significant problem for time-of-flight analysers, particularly when analysing labelled analyte ions. Nevertheless, embodiments described herein are also applicable to other MR-ToF analyser designs, such as the Verenchikov-type MR-ToF analyser.

In the embodiments depicted in FIGS. 4 and 5, the fact that the ion beam is relatively broad in the drift dimension Y means that the deflector 42b should be able to accept such a wide beam without introducing clipping or uneven deflection. A suitable deflector design is a trapezoid shaped or prism-like deflector.

Thus, the deflector 42b may comprise a trapezoid shaped or prism-like electrode arranged above the ion beam and another trapezoid shaped or prism-like electrode arranged below the ion beam. The electrodes may be located out-of-plane of the deflection, thereby allowing them to be easily made to be broad enough to accept a wide ion beam (at least compared to more conventional deflection plates that would sit at either side of the beam). The electrodes may be angled with respect to the ion beam, such that when suitable (DC) voltage(s) is (are) applied to the electrode(s), the resulting electric field induces a deflection in the ion beam. Ions may experience a relatively strong electric field at the edges of the angled electrodes, inducing a deflection. Suitable deflection voltages are of the order of ±a few volts, ±tens of volts, or ±hundreds of volts. The deflector should be (and in embodiments is) configured such that it can cause the ion beam to be deflected by a desired (selected) angle. The angle by which the ion beam is deflected by the deflector may be adjustable, e.g. by adjusting the magnitude of a (DC) voltage(s) applied to the deflector.

In embodiments, the multi-reflecting time-of-flight (MR-ToF) mass analyser is operable in a multi-pass “zoom” mode of operation. In this mode of operation, ions are made to make multiple cycles within the analyser in the drift direction Y. Increasing the number of cycles N increases the length of the ion path that ions take within the analyser (between the injector 41 and the detector 44), thereby increasing the resolution of the analyser. In the Verenchikov analyser, this may be done by controlling a voltage on an entrance lens. For the analysers depicted in FIGS. 4 and 5, the deflector 42b at the front of the analyser, which is normally used to reduce the injection angle and/or optimise the number of oscillations within a single drift pass, may (also) be used to reverse the drift direction velocity of the ions such that the ions are caused to complete a further cycle through the analyser.

Thus, in a multi-pass “zoom” mode of operation, ions are caused to complete plural (N) cycles within the analyser 40, where in each cycle the ions drift in the drift direction Y from the deflector 42b (or entrance lens) towards the opposite (second) end of the ion mirrors 43a, 43b, and then back to the deflector 42b (or entrance lens). In each cycle, the ions also complete plural reflections between the ion mirrors in the X direction. Thus, in each cycle, the ions adopt a zigzag ion path through the space between the ion mirrors 43a, 43b.

In the analysers depicted in FIGS. 4 and 5, an initial cycle may be initiated by injecting the ions from the injector 41 into the space between the ion mirrors 43a, 43b. The ions may be reflected in one of the ion mirrors 43b and may then travel to the deflector 42b. An appropriate (e.g. relatively small) voltage may be applied to the deflector 42b such that the ions are caused to exit the deflector 42b in a direction towards the second end of the ion mirrors. Upon existing the deflector 42b, the ions adopt a zigzag ion path having plural reflections between the ion mirrors 43a, 43b in the direction X whilst: (a) drifting along the drift direction Y from the deflector 42b towards the second end of the ion mirrors, (b) reversing drift direction velocity in proximity with the second end of the ion mirrors, and (c) drifting back along the drift direction Y to the deflector 42b.

After the ions have completed this initial cycle, each further cycle is initiated by using the deflector 42b to reverse the drift direction velocity of the ions (in proximity with the first end of the ion mirrors). To do this, an appropriate voltage may be applied to the deflector 42b that causes ions to leave the deflector 42b with a drift direction velocity opposite to the drift direction velocity with which the ions originally entered the deflector 42b. This voltage may be applied during a time period in which it is expected that the ions will arrive back at the deflector 42b. Suitable deflection voltages to reverse the drift direction of the ions are of the order of hundreds of volts.

The deflector may be used to reverse the drift direction velocity of the ions one or more times. Thus, the method may comprise causing the ions to complete plural (N) cycles within the analyser, where the first cycle is initiated by injecting the ions into the space between the ion mirrors, and after the ions have completed the first cycle, each further cycle may be initiated by using the deflector to reverse the drift direction velocity of the ions.

After the ions have completed the desired (plural) number (N) of cycles within the analyser, the ions are allowed to travel from the deflector 42b to the detector 44 for detection. To do this, an appropriate voltage may be applied to the deflector 42b such that the ions are caused to exit the deflector 42b in a direction towards the detector 44. The ions may be reflected in (the other) one of the ion mirrors 43a before travelling to (and being detected by) the detector 44.

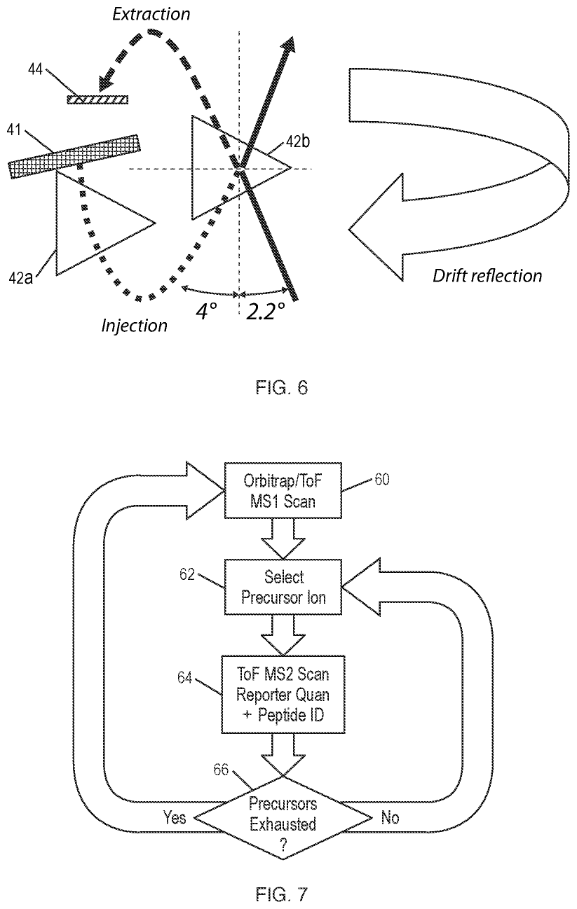

FIG. 6 illustrates schematically this zoom mode of operation. As shown in FIG. 6, ions are injected from the ion trap source 41, through a deflector 42a and between the mirrors at a relatively high angle. After the first half oscillation, ions pass a second prism shaped deflector 42b that reduces the injection angle by almost half. Oscillating ions then drift up the elongate mirror length and are turned back, e.g. by the mirrors' set tilt in the case of the analyser of FIG. 4. By the time ions return to this second deflector 42b the voltage may be switched from an injection/extraction potential of approximately −150V to a trapping potential of approximately +350V, which reflects the ion beam back into the analyser body for a second pass. After a desired number of passes (N) have been traversed by the ions, the deflector 42b is switched back to the injection/extraction potential and ions escape to the detector 44.

Embodiments are directed to methods of analysing labelled analyte molecules, such as peptides labelled with isobaric tags. The analyte molecules may be labelled with a set of isobaric tags. Isobaric tags and their uses are described in the literature (see, e.g., Thompson et al, Anal. Chem., 2003, 75, 1895-1904). A set of isobaric tags is a set of tag molecules that have (approximately) the same mass, but yield characteristic reporter ions of differing mass upon fragmentation of labelled analyte ions. Suitable isobaric tags include Tandem Mass Tags (TMT) and Isobaric Tags for Relative and Absolute Quantitation (iTRAQ). Each tag may comprise (at least) a reporter region and a balancer region, e.g. such that each labelled analyte molecule comprises (at least) a reporter region, a balancer region, and an analyte molecule (e.g. a peptide).

The labelled analyte molecules may be provided in solution, the solution may be separated using the separation device, and the separated solution from the separation device may be provided to the ion source 10 for ionisation. The ion source 10 may ionise the labelled analyte molecules to produce labelled analyte ions.

The labelled analyte ions may optionally initially be analysed in an MS1 mode of operation, so as to provide MS1 data. The MS1 data may include one or more ion peaks, with each ion peak corresponding to labelled analyte ions having a particular m/z (i.e. a particular precursor).

The labelled analyte ions may then be analysed in the MS2 mode of operation, so as to provide MS2 data. Each precursor of interest identified from the MS1 data may be used to define an m/z window for the mass filter 20. The mass filter 20 may then sequentially step through each m/z window corresponding to each precursor of interest. In this MS2 mode of operation, the fragmentation device 30 is operating in a fragmenting mode of operation. Thus, the mass filtered labelled analyte ions are sequentially fragmented in the fragmentation device 30. When labelled analyte ions are fragmented, reporter ions may be produced (where a reporter ion is an ion of a reporter region) together with analyte molecule fragment ions.

Additionally or alternatively, complementary ions may be produced (where a complementary ion is an ion of a combined balancer region and analyte molecule). Production of complementary ion requires careful control of the collision energy, e.g. to a relatively low value. This low collision energy may also produce some peptide fragments (but less efficiently than at relatively high collision energies). Alternatively, two different collision energies may be used, i.e. a low collision energy may be used to produce complementary ions, and a high collision energy may be used to produce peptide fragments. Thus, for each precursor of interest, two injections into the fragmentation device 30 may be provided at different collision energies. The resulting fragment ions may be injected into the analyser 40 (and analysed) either in a single injection (as a single packet of ions) or two injections (as two packets of ions).

The analyte fragment ions and the reporter ions or the complementary ions are analysed using the analyser 40.

With reference to the instrument depicted in FIG. 3, in embodiments, multiplexed and tagged samples are delivered to the electrospray ion source 10 from a liquid chromatography (LC) separation device, ionised and passed into vacuum to the quadrupole 20.

To perform a full mass scan (MS1), the quadrupole 20 is configured to minimise its level of isolation and transmits ions either to the C-Trap 31 and Orbitrap™ analyser 60, or to the MR-ToF analyser 40 for analysis.

To perform a fragment scan (MS2), a suitable precursor either identified from the MS1 scan (data dependent acquisition (DDA)) or run off a fixed list (data independent acquisition (DIA)) is sent to the collision cell 30 with enhanced energy and is fragmented. The fragments are then delivered to the MR-ToF analyser 40 for analysis, wherein TMT reporter ion peaks are measured for quantitation and peptide fragments are detected for identification of the precursor.

FIG. 7 illustrates this DDA process. As shown in FIG. 7, an MS1 scan is firstly performed using either the Orbitrap™ analyser 60 or the ToF analyser 40 (step 60). For the instrument design of FIG. 3, the Orbitrap™ analyser 60 may be advantageous for performing MS1 precursor identification, but it would be possible to use the ToF analyser 40 alone, and the Orbitrap™ analyser 60 is not an essential part of the instrument.

Next, a precursor ion is selected from the MS1 scan (step 62), and an MS2 scan is performed for that precursor ion using the ToF analyser 40 (step 64). As is illustrated by step 66, this process is then repeated until the list of precursor ions identified from the MS1 scan is exhausted. Once the list of precursor ions is exhausted, a new MS1 scan is performed, and the process repeats itself.

This DDA process is advantageous (and a DIA process may be disfavoured) for the TMT methods described herein. This is because quadrupole isolation widths tend to be too wide to blindly cover a ˜300-1100 mass range (as is typically done in DIA methods) with sufficient speed to be compatible with the timescale of chromatographic peaks from the separation device, whilst very narrow isolation windows are preferred to minimise interferences between co-isolated peptides. However, the complementary ion method has less difficulties with such interferences, and is much more compatible with DIA.

In embodiments, the zoom mode described above may or may not be applied within the MS1 scan(s). However, in accordance with embodiments the zoom mode is applied to the MS2 scan(s).

In this regard, it is noted is that the reporter ions appear very early in the mass spectrum, in fact lower than the instrument might normally be set to detect fragment ions of most precursors. They are also closely spaced over a few m/z units. A consequence of this is that the zoom mode may be advantageously applied just to the reporter ions, and the remaining fragment ions may pass through the instrument without interruption. It would also be possible to apply the zoom mode just to the complementary ions, which are also closely spaced over a few m/z units.

Thus, in embodiments, the analyte fragment ions are analysed using the time-of-flight mass analyser 40 operating in the first mode of operation in which ions are caused to travel along a flight path having a first length. The reporter ions or the complementary ions are analysed using the time-of-flight mass analyser 40 operating in the second mode of operation in which ions are caused to travel along a flight path having the second greater length. It has been recognised that the analyser's wide m/z range normal mode of operation is particularly suited to the analysis of peptide fragment ions (which typically appear over a relatively wide range of m/z), and the narrow m/z range but higher resolution zoom mode of operation is particularly suited to the analysis of the reporter ions (which typically appear within a relatively narrow m/z range at relatively low m/z) or complementary ions.

The resulting m/z and/or intensity information for the analyte fragment ions may be used to identify the analyte molecules, and the m/z and/or intensity information for the reporter ions or the complementary ions may be used to quantify the analyte molecules.

In the MR-ToF instrument of FIGS. 3 and 4 with a 20-25 m flight path, all injected ions pass the second deflector 42b relatively quickly, within ˜100 μs. TMT reporter ions at m/z ˜128 will return to the deflector 42b after ˜250 μs, thereby leaving a large overhead time for the deflector 42b to be switched to the internal trapping zoom mode. The reporter ions may then be reflected back into the instrument within a few microseconds and the deflector 42b may be switched back to its transmission mode, whereupon peptide fragment ions are allowed to leave the system along with the TMT reporter ions returning from their second pass. This has the effect of shifting the reporter region somewhere above 500 μs (570 μs in a real experiment, though this varies substantially with analyser tuning), which should be understood by the data analysis software.

In some embodiments, multiple short deflector voltage pulses may be aligned to the return of the TMT reporter ions, such that these ions make plural passes through the analyser, for even greater levels of performance.

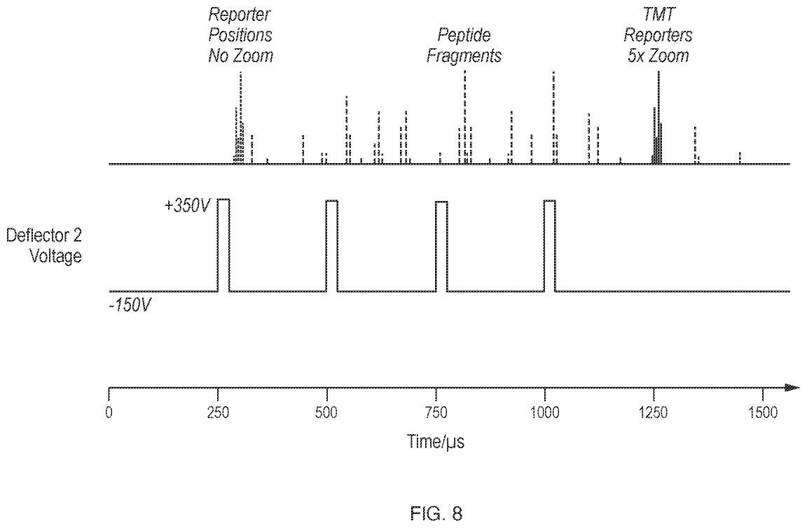

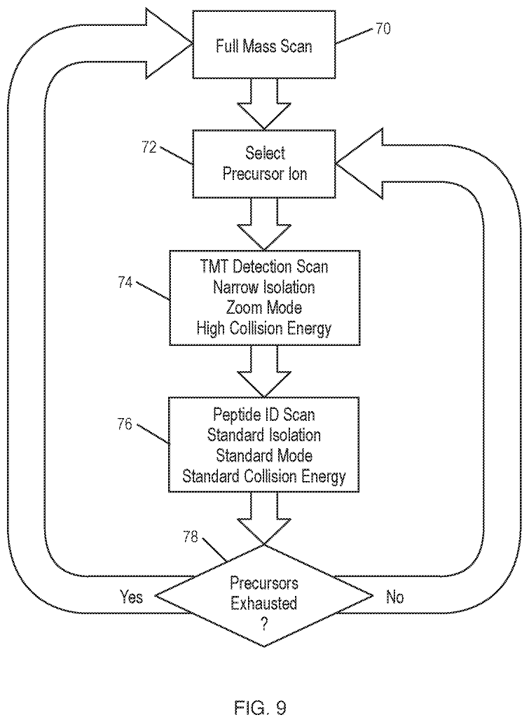

FIG. 8 illustrates a scheme where the reporter ions are sent for five passes through the analyser 40. As illustrated by FIG. 8, the voltage applied to the deflector 42b is pulsed from its injection/extraction potential (˜−150V) to its trapping potential (˜+350V) in time with the return of the TMT reporter ions, so that only the reporter ions are sent for five passes through the analyser 40, while the peptide fragment ions are subjected to a normal single pass through the analyser 40.

Thus, in embodiments, the method comprises injecting a packet of ions comprising analyte fragment ions and reporter ions or complementary ions from the ion injector 41 into the space between the ion mirrors 43a, 43b. The ions are caused to complete a first cycle in which the ions follow a zigzag ion path having plural reflections between the ion mirrors 43a, 43b in the direction X whilst: (a) drifting along the drift direction Y from the deflector 42b or lens towards the second end of the ion mirrors, (b) reversing drift direction velocity in proximity with the second end of the ion mirrors, and (c) drifting back along the drift direction Y to the deflector 42b or lens. Then, only the analyte fragment ions area allowed to travel from the deflector 42b or lens to the detector 44 for detection. The deflector 42b or lens is used to reverse the drift direction velocity of (only) the reporter ions or the complementary ions such that these ions are caused to complete a further cycle in which these ions follow a zigzag ion path having plural reflections between the ion mirrors 43a, 43b in the direction X whilst: (a) drifting along the drift direction Y from the deflector 42b or lens towards the second end of the ion mirrors, (b) reversing drift direction velocity in proximity with the second end of the ion mirrors, and (c) drifting back along the drift direction Y to the deflector 42b or lens. This step may optionally be repeated, e.g. such that the reporter ions or the complementary ions are caused to complete a desired number N of passes in the analyser Finally, the reporter ions or the complementary ions are caused to travel from the deflector 42b or lens to the detector 44 for detection.

Whilst this mode of operation has ever greater benefits in terms of TMT resolution, signal loss has been noted experimentally for multiple passes (see FIG. 11), and the notches of the deflector voltage become notches in the mass spectrum. Although resolution increases with the number of passes, signal loss also increases, and the notches become increasingly likely to snare peptide fragment ions and generate false positive peaks. Relatively fast deflector switching is needed for this operation, as is minimum residence time within the deflector 42b itself, though as this is normally on the order of ˜1 μs it is believed that the speed of power supply switching is more significant. The timings of the prism voltage switch may be calibrated and optimised on a per-instrument basis.

The focal plane position of ions arriving at the detector should be aligned to the detector surface for best resolution. However, the focal plane position may be shifted for the zoom mode versus the un-zoomed regular mode. Normally, adjustment of the focal plane can be carried out by slight perturbations of the mirror voltages, but this is not generally feasible when ions with mixed trajectories are flying through the analyser together.

In this regard, it is noted that an advantage of this method is that only the zoomed reporter ions require the highest resolution, whereas the resolution needed for the peptide fragment ions is far less demanding. Thus, in some embodiments the focal plane may be optimised only for the zoomed ions. It is also or instead possible to take advantage of the fact that the reporter ions are the lowest m/z ions in the spectrum, the earliest to emerge from the trap 41, and so may be exposed to differing controlled voltages within the trap 41 (such as, for example, a slowly rising extraction pulse), within the injection optics 46, 42a, 47, 42b, fringes of the mirrors 43a, 43b, and/or at the detector 44 to adjust the focal plane without influencing other ions. It would also or instead be possible to employ an m/z dependent ion energy correction method, e.g. as described in U.S. Pat. No. 10,727,039, the contents of which are incorporated herein by reference. It would also or instead be possible to apply a small oscillating voltage of controlled frequency and phase, to the mirrors 43a, 43b in resonance with the oscillation of the low m/z reporter ions, giving a focal plane adjustment that solely affects the reporter ions.

FIG. 9 shows a workflow according to further embodiments, where rather than making the reporter ion measurement in the same scan as the peptide fragments, they are instead measured in a separate scan.

As shown in FIG. 9, an MS1 full mass scan is firstly performed (step 70), and a precursor ion is selected from the MS1 scan (step 72). Next, a first MS2 scan is performed using the zoom mode to detect the TMT reporter ions (step 74), and then a second MS2 scan is performed using the regular mode of operation to detect the peptide fragment ions (step 76). The order of steps 74 and 76 could be reversed. As is illustrated by step 78, this process is then repeated until the list of precursor ions identified from the MS1 scan is exhausted. Once the list of precursor ions is exhausted, a new MS1 scan is performed, and the process repeats itself.

Thus, in embodiments the analyte fragment ions are analysed as one or more first packets of ions injected into the analyser 40, and the reporter ions or the complementary ions comprises are analysed as one or more second different packets of ions injected into the analyser 40.

This method has the advantage that instrument settings may be optimized for each of the two MS2 scans, for example by tuning of the mirrors 43a, 43b for resolution, and/or optimisations of RF and DC voltages for the differing target mass ranges of reporter ions and peptide fragment ions, e.g. so as to optimise the collision energy for each of the two scans, to optimise the injection voltages applied to the ion trap 41 for each of the two scans and/or to optimise the mass filter's isolation window for each of the two scans.

In these embodiments, a notched method similar to the method illustrated by FIG. 8 may optionally still be used for the TMT scan, except that rather than the deflector 42b being set to transmit ions between notches it is instead set to an extreme voltage to remove all peptide fragment ions from the spectrum.

These embodiments have an additional cost in terms of raw sensitivity and acquisition speed, however the maximum acquisition speed of the MR-ToF analyser 40 is many times higher than an Orbitrap™ analyser operating at 50 Hz, and some sensitivity may be regained by separately optimisation of the collision energies (higher energy is better for low m/z ions such as reporter ions, but less preferred for mid/high m/z fragment ions), trapping RF etc. Advantageously, the quadrupole 20 isolation window may be narrowed for the TMT scan to remove interferences, and widened for the peptide scan in order to maximize sensitivity. Generally, ˜10,000 detected ions are preferred for peptide identification, but far less are needed for reporter ion quantitation, especially given the single ion level detection provided by ToF analysers.

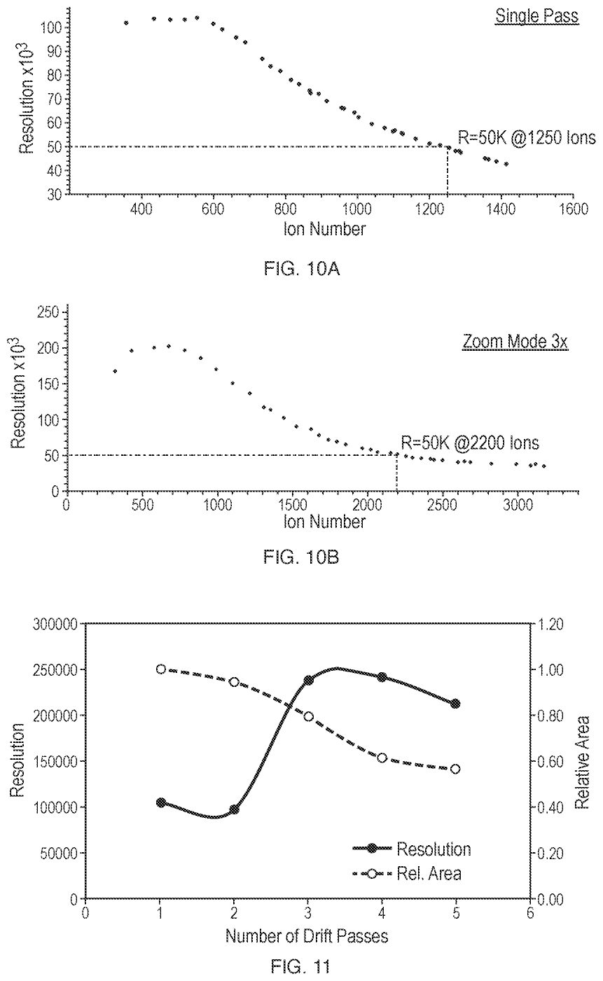

FIG. 10 shows experimental results for the space charge induced resolution loss of the analyser of FIG. 4 for the single pass and zoom modes, using MRFA ions generated from a Flexmix™ sample. It can be seen that not only is the top-end resolution roughly doubled in the zoom mode, but also the resilience towards space charge is also almost doubled (that is, the number of ions in a peak where the 50K resolution requirement is achieved is almost twice as many).

FIG. 11 shows plots of experiments where the level of zoom mode (i.e., the number of passes where ions drift up and down the analyser) are varied. It can be seen that 3 passes are optimal for achieving high resolution and minimal signal loss with this analyser design. Other MR-ToF analyser designs however are likely to behave differently, for example 500K resolution has previously been observed on analysers incorporating periodic lenses (e.g., as described in UK Patent No. 2,403,063).

It will be appreciated from the above that embodiments provide a method in which a zoom mode is used to enhance detection of a TMT reporter region (or complementary ion region). This may be done either as its own scan with an optimised isolation window, collision energy etc., or may be integrated into a wider scan, e.g. via notched switching of the deflector 42b voltage.

In accordance with embodiments, TMT reporter ions can be identified via the zoom mode using an MR-ToF analyser that does not otherwise meet the requirement for >50K resolution at the desired dynamic range. The reporter region often contains thousands of ions, whereas an MR-ToF analyser may be capable of separating a 100:1 TMT doublet at only a thousand ions total. This translates to a rather limited dynamic range over which the smaller peak is observable. FIGS. 10 and 11 show the intrinsic advantages of using the zoom mode to escape these limitations.

As described above, integrating the zoom mode TMT scan into the standard main scan means that no loss of repetition rate or sensitivity is incurred. However, this is optional, and it may be advantageous to make these scans separately, as the ToF analyser is already much faster than is required. Relatively long/slow-throughput experimental cycles may be performed due to the need for high quality chromatographic separation. This may be improved by having separate narrow isolation window reporter ion scans with lower interferences. Sensitivity then becomes a more significant issue, but this can be salvaged by more optimal instrument settings.

The zoom mode can also increase the resolution sufficiently for 16 or 18-plex complementary ion TMT methods to become possible. These methods are currently not possible in any ToF system. Resolution improvements are also valuable for lower multiplexed complementary ions, e.g. to resolve out chemical noise and co-isolated peptides, allowing larger isolation widths and even higher throughputs.

Although various particular embodiments have been described above, various alternative embodiments are possible.

For example, the methods described herein can be carried out on any instrument incorporating a ToF analyser capable of altering the ion flight path length, e.g. by altering the number of reflections taken by ions through the analyser. For example, this could be from zero (linear ToF) reflections to a single reflection. This could also involve a switch between a low sensitivity W-shaped ion flight path and a high sensitivity low-resolution V-shaped ion flight path. In general, all multi-reflection and multi-turn ToFs may be used to perform the methods described herein.

With reference to the embodiments described in relation to FIG. 9, instead of the interleaved sequence of reporter ion scans and peptide fragment ion scans shown in FIG. 9, a sequence of TMT reporter ion scans may be made followed by a sequence of peptide fragment ion scans. This may be beneficial if there is a relatively slow voltage shift that must be made when switching from the regular mode to the zoom mode. For example, stabilised power supplies can take many milliseconds to adjust.

More efficient methods may be performed where a tagged analyte is identified by one MS2 scan, and then a second MS2 scan is made to quantify the tags.

A similar level of interference might be detected from the MS1 scan. Chemical interference in the reporter ions comes from fragmentation of co-isolated tagged peptides. In principle it should be possible to see these interference peptide peaks in the MS1 scan, within the same mass isolation window as the target peptide. Based on the MS1 scan (or analyte MS2 scan which will normally still show substantial amounts of unfragmented precursor ions), the isolation window may be set dynamically to balance transmission and minimise interferences.

The MS2 TMT scan (or the combined TMT/precursor scan) may be replaced by an MS3 scan, which is less sensitive but better for low-interference quantitation. Such a method may be performed by an instrument containing a device for further isolation and fragmentation, such as a linear ion trap, or by passing ions back through the quadrupole 20. Again, there is an advantage here in using the more sensitive method for fragment ion detection and the cleaner method for improved reporter ion quantitation.

The notched switching method described above may be more widely applicable to picking out target analytes requiring high resolution in a range of other applications.

For example, the notched switching mode may be used to pick out a target from a background of unknowns. This may be useful for protein DIA/DDA, where a precursor may be analysed in zoom mode, to optimally resolve the isotopic envelope (which requires high resolution), whilst the lower m/z fragment ions (with lower resolution requirements) may be detected normally. Even standard peptide and/or regular m/z ion DDA/DIA may benefit, as better mass accuracy and separation of different precursors is obtained in the MS2 spectrum. Targeted applications such as SIM scanning may also benefit if it is desired for the target ion to be detected with maximum performance, but masses of any fragments are also desired.

In general, these methods may be applied to any application where one or several target ions (known or determined by a previous scan) require high resolution/dynamic range, versus a background of unknown or low abundance ions for which it is desired not to suffer the m/z measurement uncertainty or sensitivity loss induced by zoom mode.

Although the present invention has been described with reference to various embodiments, it will be understood that various changes may be made without departing from the scope of the invention as set out in the accompanying claims.

1. A method of analysing labelled analyte ions, the method comprising:
fragmenting labelled analyte ions to produce analyte fragment ions and reporter ions or complementary ions;
analysing the analyte fragment ions using a time-of-flight mass analyser operating in a first mode of operation in which ions are caused to travel along a flight path having a first length; and
analysing the reporter ions or the complementary ions using the time-of-flight mass analyser operating in a second mode of operation in which ions are caused to travel along a flight path having a second length, wherein the second length is greater than the first length.

2. The method of claim 1, wherein:
the time-of-flight mass analyser comprises one or more ion reflectors;
in the first mode of operation ions are caused to make n reflection(s) in the one or more ion reflectors, wherein n is an integer ≥0; and
in the second mode of operation ions are caused to make m reflection(s) in the one or more ion reflectors, wherein m is an integer >n.

3. The method of claim 1, wherein the time-of-flight mass analyser is a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors; and
a detector for detecting ions after they have completed a plurality of reflections between the ion mirrors, the detector located in proximity with the first end of the ion mirrors;
wherein analysing analyte fragment ions using the analyser operating in the first mode of operation comprises:
injecting analyte fragment ions from the ion injector into the space between the ion mirrors, wherein the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y to the first end of the ion mirrors; and then
causing the ions to travel to the detector for detection.

4. The method of claim 3, wherein analysing reporter ions or complementary ions using the analyser operating in the second mode of operation comprises:
(i) injecting reporter ions or complementary ion from the ion injector into the space between the ion mirrors, wherein the ions complete a first cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(ii) reversing the drift direction velocity of the ions in proximity with the first end of the ion mirrors such that the ions are caused to complete a further cycle in which the ions follow a zigzag ion path having plural reflections between the ion mirrors in the direction X whilst: (a) drifting along the drift direction Y towards the second end of the ion mirrors, (b) reversing drift direction velocity in proximity with the second end of the ion mirrors, and (c) drifting back along the drift direction Y towards the first end of the ion mirrors;
(iii) optionally repeating step (ii) one or more times; and then
(iv) causing the ions to travel to the detector for detection.

5. The method of claim 3, wherein:
the multi-reflection time-of-flight (MR-ToF) mass analyser further comprises a deflector or lens located in proximity with the first end of the ion mirrors; and
analysing reporter ions or complementary ions using the analyser operating in the second mode of operation comprises:
(i) injecting reporter ions or complementary ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) using the deflector or lens to reverse the drift direction velocity of the ions such that the ions are caused to complete a further cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iii) optionally repeating step (ii) one or more times; and then
(iv) causing the ions to travel from the deflector or lens to the detector for detection.

6. The method of claim 1, wherein the step of analysing the analyte fragment ions comprises analysing one or more first packets of ions, and the step of analysing the reporter ions or the complementary ions comprises analysing one or more second different packets of ions.

7. The method of claim 6, further comprising generating and/or processing and/or analysing each first packet of ions using a first set of one or more instrument parameters, and generating and/or processing and/or analysing each second packet of ions using a second different set of one or more instrument parameters.

8. The method of claim 6, further comprising generating each first packet of ions using a first mass filter transmission window width, and generating each second packet of ions using a second different mass filter transmission window width.

9. The method of claim 6, further comprising generating each first packet of ions using a first collision energy, and generating each second packet of ions using a second different collision energy.

10. The method of claim 1, wherein the steps of analysing the analyte fragment ions and analysing the reporter ions or the complementary ions comprises analysing one or more single packets of ions.

11. The method of claim 10, wherein the analyser comprises:
an ion path comprising a cyclic segment;
an ion injector for injecting ions into the ion path;
at least one ion reflector arranged along the ion path; and
a detector arranged at the end of the ion path;
wherein the method comprises:
(i) injecting a packet of ions comprising analyte fragment ions and reporter ions or complementary ions from the ion injector into the ion path such that the analyte fragment ions and the reporter ions or the complementary ions travel along the ion path to the ion reflector;
(ii) causing the analyte fragment ions to travel from the ion reflector to the detector for detection;
(iii) using the ion reflector to cause the reporter ions or the complementary ions to complete one or more cycles along the cyclic segment of the ion path; and then
(iv) causing the reporter ions or the complementary ions to travel from the ion reflector to the detector for detection.

12. The method of claim 10, wherein the time-of-flight mass analyser is a multi-reflection time-of-flight (MR-ToF) mass analyser comprising:
two ion mirrors spaced apart and opposing each other in a first direction X, each mirror elongated generally along a drift direction Y between a first end and a second end, the drift direction Y being orthogonal to the first direction X;
an ion injector for injecting ions into a space between the ion mirrors, the ion injector located in proximity with the first end of the ion mirrors;
a deflector or lens located in proximity with the first end of the ion mirrors; and
a detector for detecting ions after they have completed a plurality of reflections between the ion mirrors, the detector located in proximity with the first end of the ion mirrors; and
wherein the method further comprises:
(i) injecting a packet of ions comprising analyte fragment ions and reporter ions or complementary ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing the analyte fragment ions to travel from the deflector or lens to the detector for detection;
(iii) using the deflector or lens to reverse the drift direction velocity of the reporter ions or the complementary ions such that these ions are caused to complete a further cycle in which these ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the reporter ions or the complementary ions to travel from the deflector or lens to the detector for detection.

13. The method of claim 1, wherein the method comprises:
analysing labelled analyte ions in an MS1 mode of operation so as to produce MS1 data, and identifying one or more precursors of interest in the MS1 data;
wherein the step of fragmenting labelled analyte ions comprises sequentially selecting and fragmenting each identified precursor of interest.

14. The method of claim 1, further comprising:
ionising labelled analyte molecules to produce the labelled analyte ions; and
using mass to charge ratio (m/z) and/or intensity information from the analysis of the analyte fragment ions to identify the analyte molecules, and using mass to charge ratio (m/z) and/or intensity information from the analysis of the reporter ions or the complementary ions to quantify the analyte molecules.

15. The method of claim 1, wherein the labelled analyte ions are ions of peptides labelled with isobaric tags.

16. A method of operating a time-of-flight (ToF) mass analyser that comprises:
an ion path comprising a cyclic segment;
an ion injector for injecting ions into the ion path;
at least one ion reflector arranged along the ion path; and
a detector arranged at the end of the ion path;
the method comprising:
(i) injecting a packet of ions comprising first ions and second ions from the ion injector into the ion path such that the first ions and the second ions travel along the ion path to the ion reflector;
(ii) causing the first ions to travel from the ion reflector to the detector for detection;
(iii) using the ion reflector to cause the second ions to complete one or more cycles along the cyclic segment of the ion path; and then
(iv) causing the second ions to travel from the ion reflector to the detector for detection.

17. The method of claim 16, wherein the time-of-flight (ToF) mass analyser is a multi-reflection time-of-flight (MR-ToF) mass analyser that comprises:
two ion mirrors spaced apart and opposing each other in a first direction X, each mirror elongated generally along a drift direction Y between a first end and a second end, the drift direction Y being orthogonal to the first direction X;
wherein the ion injector is configured to inject ions into a space between the ion mirrors, and the ion injector is located in proximity with the first end of the ion mirrors;
wherein the detector is configured to detect ions after they have completed a plurality of reflections between the ion mirrors, and the detector is located in proximity with the first end of the ion mirrors; and
wherein the ion reflector comprises a deflector or lens located in proximity with the first end of the ion mirrors;
wherein the method comprises:
(i) injecting a packet of ions comprising first ions and second ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing the first ions to travel from the deflector or lens to the detector for detection;
(iii) using the deflector or lens to reverse the drift direction velocity of the second ions such that the second ions are caused to complete a further cycle in which the second ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the second ions to travel from the deflector or lens to the detector for detection.

18. An analytical instrument, comprising:
a fragmentation device;
a time-of-flight (ToF) mass analyser operable in a first mode of operation in which ions are caused to travel along a flight path having a first length, and a second mode of operation in which ions are caused to travel along a flight path having a second length, wherein the second length is greater than the first length; and
a control system configured, when the instrument is being used to analyse labelled analyte ions, to:
cause the fragmentation device to fragment the labelled analyte ions to produce analyte fragment ions and reporter ions or complementary ions;
cause the time-of-flight mass analyser to analyse the analyte fragment ions using the first mode of operation; and
cause the time-of-flight mass analyser to analyse the reporter ions or the complementary ions using the second mode of operation.

19. A time-of-flight (ToF) mass analyser comprising:
an ion path comprising a cyclic segment;
an ion injector for injecting ions into the ion path;
at least one ion reflector arranged along the ion path; and
a detector arranged at the end of the ion path;
wherein the analyser is configured to analyse ions by:
(i) injecting a packet of ions comprising first ions and second ions from the ion injector into the ion path such that the first ions and the second ions travel along the ion path to the ion reflector;
(ii) causing the first ions to travel from the ion reflector to the detector for detection;
(iii) using the ion reflector to cause the second ions to complete one or more cycles along the cyclic segment of the ion path; and then
(iv) causing the second ions to travel from the ion reflector to the detector for detection.

20. The analyser of claim 19, wherein:
the time-of-flight (ToF) mass analyser is a multi-reflection time-of-flight (MR-ToF) mass analyser that comprises two ion mirrors spaced apart and opposing each other in a first direction X, each mirror elongated generally along a drift direction Y between a first end and a second end, the drift direction Y being orthogonal to the first direction X;
the ion injector is configured to inject ions into a space between the ion mirrors, and the ion injector is located in proximity with the first end of the ion mirrors;
the detector is configured to detect ions after they have completed a plurality of reflections between the ion mirrors, and the detector is located in proximity with the first end of the ion mirrors; and
the ion reflector is a deflector or lens located in proximity with the first end of the ion mirrors;
wherein the analyser is configured to analyse ions by:
(i) injecting a packet of ions comprising first ions and second ions from the ion injector into the space between the ion mirrors, wherein the ions complete a first cycle in which the ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(ii) causing the first ions to travel from the deflector or lens to the detector for detection;
(iii) using the deflector or lens to reverse the drift direction velocity of the second ions such that the second ions are caused to complete a further cycle in which the second ions follow a zigzag ion path having plural reflections between the ion mirrors in the direction X whilst: (a) drifting along the drift direction Y from the deflector or lens towards the second end of the ion mirrors, (b) reversing drift direction velocity in proximity with the second end of the ion mirrors, and (c) drifting back along the drift direction Y to the deflector or lens;
(iv) optionally repeating step (iii) one or more times; and then
(v) causing the second ions to travel from the deflector or lens to the detector for detection.
